(19) United States
(12) Patent Application Publication
(10) Pub. No.: US 2008/0220849 A1
(43) Pub. Date: Sep. 11, 2008

(54) Presenting Streaming Video Content in a Gaming Machine

(76) Inventors: William Wadleigh, Cedar falls, IA (US); Craig J. Sylla, Round Lake, IL (US); Paul Radek, Naperville, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 12/063,815

(22) PCT Filed: Aug. 16, 2006
(86) PCT No.: PCT/US2006/032023

§ 371 Date: Feb. 14, 2008

Related U.S. Application Data
(60) Provisional application No. 60/708,574, filed on Aug. 16, 2005.

(51) Int. Cl. A63F 9/24; G06F 17/00

(52) U.S. Cl. 463/20; 463/31; 463/43

(57) ABSTRACT

Systems and methods for presenting streaming video content in a gaming machine are described herein. In one embodiment, the method includes detecting satisfaction of a condition in a wagering game and determining which one of a plurality of streaming video effects are associated with the condition. The method can also include applying to a streaming video segment the one of the plurality of streaming video effects associated with the condition and displaying the streaming video segment on a display device.

### RELATED APPLICATIONS

This application claims the priority benefit of U.S. Provisional Application Ser. No. 60/708,574, filed Aug. 16, 2005, the contents of which are incorporated herein by reference.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2005, 2006, WMS Gaming, Inc.

### FIELD

This invention relates generally to the field of wagering game machines and more particularly to the field of presenting video content on a wagering game machine.

### BACKGROUND

Wagering game makers continually provide new and entertaining games. One way of increasing entertainment value associated with casino-style wagering games (e.g., video slots, video poker, video black jack, and the like) includes offering a variety of base games and bonus events. Additional entertainment value can be added by devising new techniques for presenting gaming content. For example, some gaming machines present gaming content using three dimensional rendering techniques. Three dimensional rendering techniques are mathematical modeling techniques for converting high-level object-based descriptions (e.g., an outline drawing) into fully formed three-dimensional images. These rendering techniques can include ray tracing, volume rendering, surface rendering, etc. Some gaming devices use rendering techniques for presenting game results and/or for entertaining players. For example, in some slot machines, the slot machine reels are often represented by rendered images.

One disadvantage of presenting gaming results using rendered graphics is that players often associate rendered images with video amusement games. When players make such an association, they may avoid certain gaming devices; thus causing reduced popularity and revenues.

### BRIEF DESCRIPTION OF THE FIGURES

The present invention is illustrated by way of example and not limitation in the Figures of the accompanying drawings in which:

FIG. 1 is a block diagram illustrating components of a gaming machine, used in conjunction with example embodiments of the invention;

FIG. 2 is a block diagram illustrating components of a video unit, according to example embodiments of the invention;

FIG. 3 is a perspective view of a gaming machine, according to example embodiments of the invention;

FIG. 4 is a flow diagram illustrating operations for presenting streaming video content in a gaming machine, according to example embodiments of the invention;

FIG. 5 is a block diagram illustrating native and mirrored streaming video segments, according to example embodiments of the invention;

FIG. 6 is a flow diagram illustrating operations for presenting streaming video using mirroring effects, according to example embodiments of the invention;

FIG. 7 is a block diagram illustrating a wagering game in which there is a streaming video presentation, according to example embodiments of the invention;

FIG. 8 is a block diagram illustrating a slots game including a streaming video presentation, according to example embodiments of the invention;

FIG. 9 is a flow diagram illustrating operations for conducting a wagering game in which streaming video is presented, according to example embodiments of the invention;

FIG. 10 is a block diagram illustrating video streams mapped to surfaces of a cube, according to example embodiments of the invention;

FIG. 11 is a block diagram illustrating a video stream mapped to a surface of cylinder, according to example embodiments of the invention;

FIG. 12 is a flow diagram illustrating operations for conducting wagering game in which streaming video segments are presented on three dimensional shapes, according to example embodiments of the invention;

FIG. 13 is a block diagram illustrating a game scene in which multiple streaming video segments are presented simultaneously, according to example embodiments of the invention; and

FIG. 14 is a flow diagram illustrating operations for presenting multiple streaming video segments in a video game scene, according to example embodiments of the invention.

### OVERVIEW OF SOME EMBODIMENTS

Systems, methods, and machine-readable media including instructions for presenting streaming video content in a gaming machine are described herein. In one embodiment, a wagering game machine includes a gaming control unit to conduct a wagering game and a bonus event and to detect occurrence of a trigger event, the trigger event to occur during the wagering game or bonus event. The gaming machine can also include a streaming video store to store a plurality of streaming video segments. The gaming machine can also include a video unit to process one or more of a plurality of streaming video segments as part of the wagering game. The video unit can include a streaming video processing unit to add streaming video effects to ones of the plurality of streaming video segments, wherein the streaming video effects are associated with the trigger event. The video unit can also include a video codec to decode the plurality of streaming video segments and a display unit to present the streaming video segments.

In one embodiment the wagering game is selected from the group consisting of slots, poker, blackjack, and roulette. In one embodiment, the plurality of streaming video segments are encoded according to any of MPEG, AVI, WVM, QuickTime®, RealPlayer®, DivX®, RealNetworks® video encoding formats. In one embodiment, the trigger event includes slot machine reels aligned along a payline. In one embodiment, the trigger event occurs during the bonus event, and wherein the trigger event includes receiving player input. In one embodiment, the streaming video processing unit to add streaming video effects to ones of the plurality of streaming video segments by changing aspect ratios, modifying lighting, mirroring, zooming, fusing, fading, or cutting between the ones of the plurality of streaming video segments. In one embodiment, the streaming video store is selected from the group consisting of a DVD drive, CD-ROM drive, hard disk drive, or semiconductor memory device.

In one embodiment, a method includes detecting satisfaction of a condition in a wagering game, determining which one of a plurality of streaming video effects are associated with the condition, applying to a streaming video segment the one of the plurality of streaming video effects associated with the condition, and displaying the streaming video segment on a display device. In one embodiment, the condition is associated with a bonus event of the wagering game. In one embodiment, the condition is satisfied in-part by a result of a random number generator. In one embodiment, the condition is satisfied in-part by player input. In one embodiment, the plurality of streaming video effects include modifying an aspect ratio of the streaming video segment, mapping the streaming video segment to a side of a three dimensional shape, applying lighting effects to the streaming video segment, wrapping the streaming video segment around a three dimensional shape, or mirroring the streaming video segment. In one embodiment, the displaying the streaming video segment includes presenting at least 14 video frames per second.

In one embodiment a machine-readable medium which when executed by a machine causes the machine to perform operations comprising conducting a wagering game or bonus event. In one embodiment, the conducting includes, detecting a trigger event, selecting a streaming video segment and video effects, the selecting based on the trigger event, processing the streaming video segment with the video effects, and presenting the processed streaming video on a display. In one embodiment, the trigger event includes satisfaction of a wagering game condition, user input received under certain game conditions, random number generator results, or occurrence of a game state. In one embodiment the operations further comprise decoding the streaming video according to any of MPEG, AVI, WVM, or QuickTime formats. In one embodiment, the video effects include mirroring the streaming video segment, mapping the streaming video segment to a side of a three dimensional shape, or chroma keying the streaming video segment. In one embodiment, the displaying the streaming video segment includes presenting at least 14 video frames per second. In one embodiment, the operations further comprise receiving the streaming video segment from a DVD drive, CD-ROM drive, hard disk drive, semiconductor memory device, or network interface.

### DESCRIPTION OF THE EMBODIMENTS

Systems and methods for presenting streaming video content in a gaming machine are described herein. This description of the embodiments is divided into three sections. The first section describes an example operating environment and system architecture, while the second section describes example operations and streaming video concepts. The third section provides some general comments.

### Hardware, Operating Environment, and System Architecture

This section provides an example system architecture in which embodiments of the invention can be practiced. This section also describes an example gaming machine. Operations of the system components will be described in the next section.

### Example System Architecture

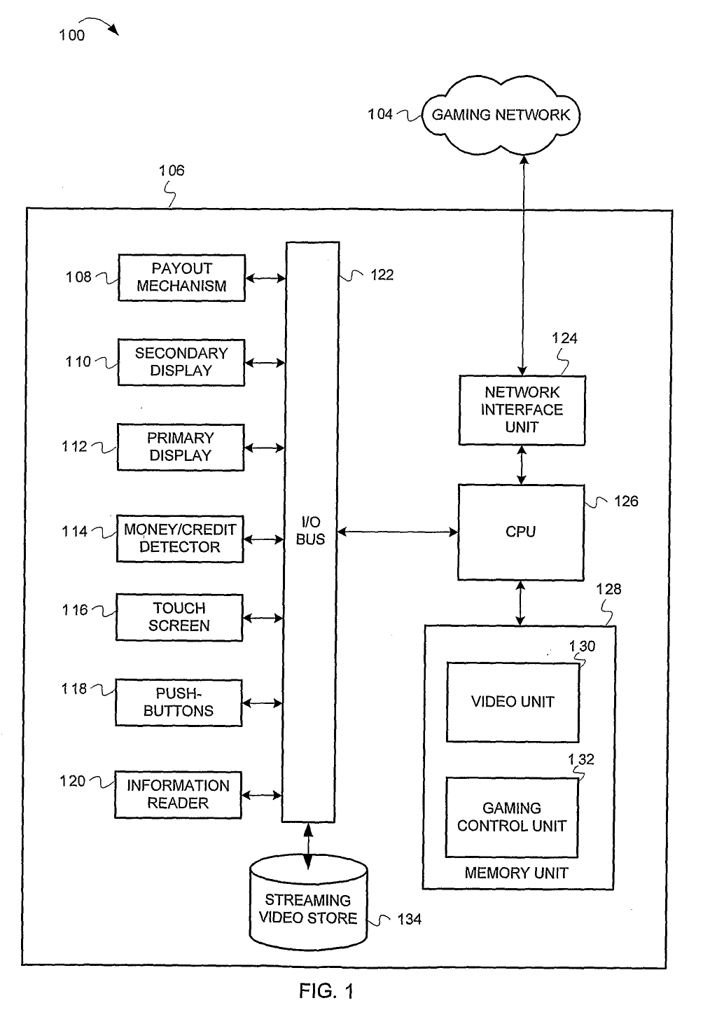

FIG. 1 is a block diagram illustrating components of a gaming machine, used in conjunction with example embodiments of the invention. As shown in FIG. 1, the gaming machine 106 includes a central processing unit (CPU) 126 connected to a memory unit 128, which includes a video unit 130 and a gaming control unit 132.

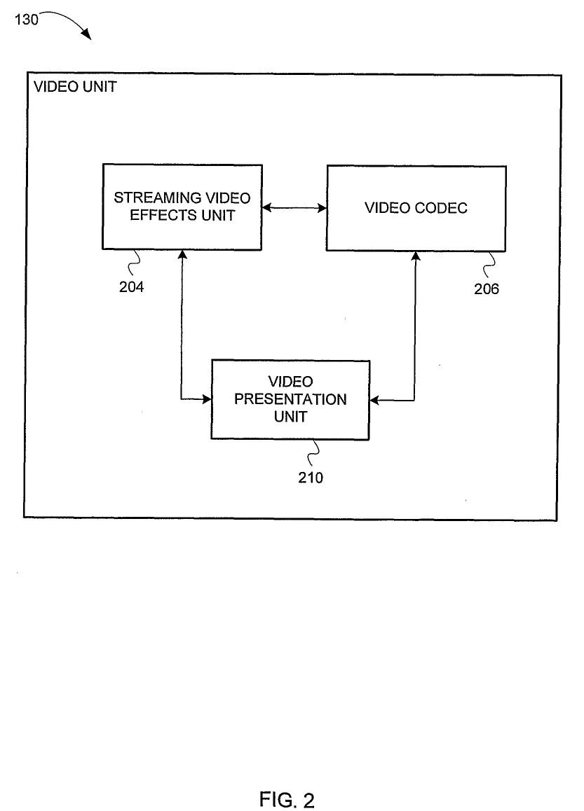

The video unit 130 is described in greater detail below, in the discussion of FIG. 2. According to embodiments, the gaming control unit 132 can conduct any suitable casino-style wagering game (including bonus events), such as video poker, video black jack, video slots, etc. The gaming control unit 132 can include a random number generator or other logic for determining wagering game results.

According to some embodiments, the gaming control unit 132 and video unit 130 can include tangible machine-readable media including instructions for conducting a basic wagering game, conducting a bonus game, presenting streaming video content, etc. Machine-readable media includes any mechanism that provides (i.e., stores and/or transmits) information in a form readable by a machine (e.g., a computer). For example, tangible machine-readable media includes semiconductor read only memory (ROM), semiconductor random access memory (RAM), magnetic disk storage media, optical storage media, flash memory devices, or any other suitable tangible media for providing instructions and/or data.

The CPU 126 is connected to a network interface unit 124, which is connected to a gaming network 104. The CPU 126 is also connected to an input/output (I/O) bus 122. The I/O bus 122 is connected to a streaming video store 134, which can be any suitable persistent storage device capable of storing streaming video segments. The streaming video store 134 can be a DVD drive, CD-ROM drive, hard disk drive, semiconductor memory device, etc.

The I/O bus 122 is also connected to payout mechanism 108, secondary display 110, primary display 112, money/credit detector 114, touchscreen 116, push-buttons 118, and information reader 120. The I/O bus 122 facilitates communication between the system components and the CPU 126.

According to some embodiments, the gaming machine 106 can include additional peripheral devices and/or more than one of each component shown in FIG. 1. For example, in one embodiment, the gaming machine 106 can include multiple network interface units 124 and multiple CPUs 126. Additionally, the components of the gaming machine 106 can be interconnected according to any suitable interconnection architecture (e.g., directly connected, hypercube, etc.).

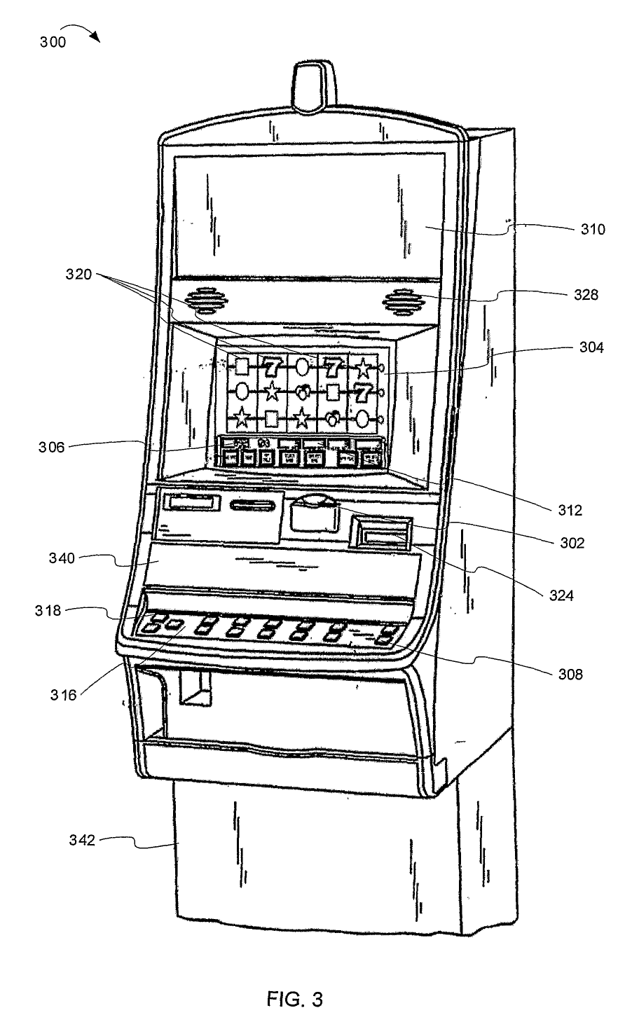

Additional details about gaming machines used in conjunction with embodiments of the invention are described below, in the discussion of FIG. 3. While FIG. 1 describes a block diagram of a gaming machine, FIG. 2 describes the video unit 130 in greater detail.

FIG. 2 is a block diagram illustrating components of a video unit, according to example embodiments of the invention. As shown in FIG. 2, the gaming video unit 130 includes the video effects unit 204, video codec 206, and video presentation unit 210. In the video unit 130, each unit is connected to the other units. According to embodiments, these components can include software, hardware, machine-readable media, and/or other logic for performing the operations described herein. The video unit's components can communicate according to any suitable communication technique, such as parameter passing, message passing, signaling, etc.

According to embodiments, the video unit 130 presents streaming video segments that include full or partial frame video images played-back at 14 frames per seconds or greater (e.g. 29.9 frames per second). In one embodiment, the video effects unit 204 can process streaming video segments to create various video effects for the video segments. The video codec (encoder/decoder) 206 can decode streaming video according to any suitable video encoding format (e.g., MPEG, AVI, QuickTime®, DivX®, RealNetworks®, or other suitable video format), while the video presentation unit 210 presents decoded streaming video on the primary display unit 112 or secondary display unit 110. Operations of the components shown in FIGS. 1 and 2 will be described in greater detail below, in the System Operations section.

While FIGS. 1 and 2 describe components of the gaming machine, FIG. 3 provides additional details about gaming machines which can be used with embodiments of the invention.

FIG. 3 is a perspective view of a gaming machine, according to example embodiments of the invention. As shown in FIG. 3, the gaming machine 300 can be a computerized slot machine having the controls, displays, and features of a conventional slot machine.

The gaming machine 300 can be mounted on a stand 342 or it can be constructed as a pub-style tabletop game (not shown). As a result, the gaming machine 300 can be operated while players are standing or seated. Furthermore, the gaming machine 300 can be constructed with varying cabinet and display designs. The gaming machine 300 can incorporate any primary game such as slots, poker, or keno, and additional bonus round games. The symbols and indicia used on and in the gaming machine 300 can take mechanical, electrical, or video form.

As illustrated in FIG. 3, the gaming machine 300 includes a coin slot 302 and bill acceptor 324. Players can place coins in the coin slot 302 and paper money or ticket vouchers in the bill acceptor 324. Other devices can be used for accepting payment. For example, credit/debit card readers/validators can be used for accepting payment. Additionally, the gaming machine 300 can perform electronic funds transfers and financial transfers to procure monies from financial accounts. When a player inserts money in the gaming machine 300, a number of credits corresponding to the amount deposited are shown in a credit display 306. After depositing the appropriate amount of money, a player can begin playing the game by pushing play button 308. The play button 308 can be any play activator used for starting a wagering game or sequence of events in the gaming machine 300.

As shown in FIG. 3, the gaming machine 300 also includes a bet display 312 and one or more “bet” buttons on the panel 316. The player can place a bet by pushing one or more of the bet buttons on the panel 316. The player can increase the bet by one or more credits each time the player pushes a bet button. When the player pushes a “bet one” button, the number of credits shown in the credit display 306 decreases by one credit, while the number of credits shown in the bet display 312 increases by one credit.

A player may end the gaming session or “cash-out” by pressing a cash-out button 318. When a player cashes-out, the gaming machine 300 dispenses a voucher or currency corresponding to the number of remaining credits. The gaming machine 300 may employ other payout mechanisms such as credit slips (which are redeemable by a cashier) or electronically recordable cards (which track player credits), or electronic funds transfer.

The gaming machine also includes a primary display unit 304 and a secondary display unit 310 (also known as a “top box”). The gaming machine may also include an auxiliary video display 340. In one embodiment, the primary display unit 304 displays a plurality of video reels 320. According to embodiments of the invention, the display units 304 and 310 can include any visual representation or exhibition, including moving physical objects (e.g., mechanical reels and wheels), dynamic lighting, and video images. In one embodiment, each reel 320 includes a plurality of symbols such as bells, hearts, fruits, numbers, letters, bars or other images, which correspond to a theme associated with the gaming machine 300. According to embodiments, the gaming machine 300 can present streaming video content, as further described herein. Additionally, the gaming machine 300 also includes an audio presentation unit 328. The audio presentation unit 328 can include audio speakers or other suitable sound projection devices.

### System Operations

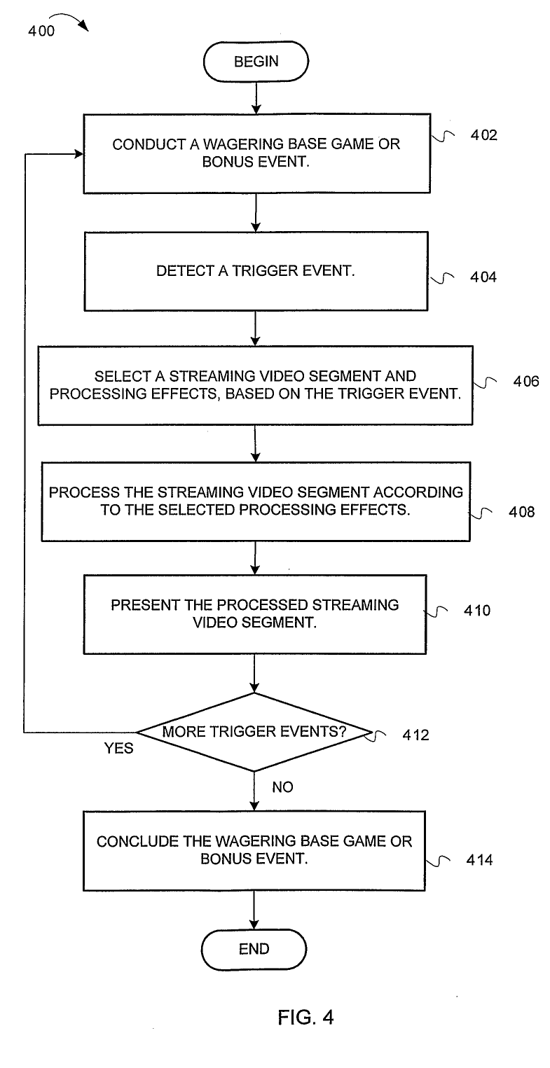

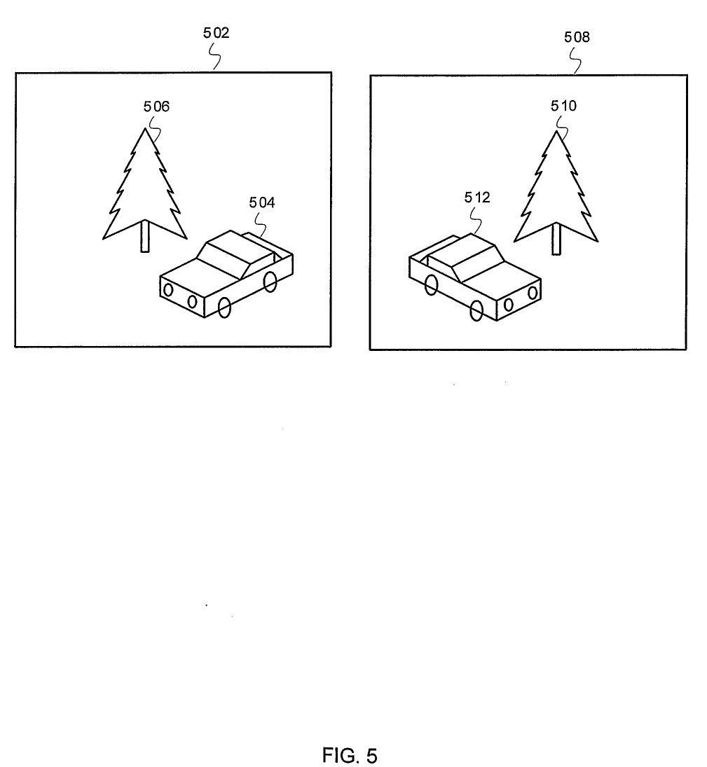

This section describes operations performed by embodiments of the invention. In this section, FIGS. 4-14 are discussed. FIG. 4 describes general operations for presenting streaming video in a gaming machine, while FIGS. 5-14 show operations and conceptual diagrams describing specific game scenarios in which gaming machines present streaming video. In the discussion below, the flow diagrams will be described with reference to the block diagrams presented above. In certain embodiments, the operations are performed by instructions residing on machine-readable media (e.g., software), while in other embodiments, the operations are performed by hardware and/or other logic (e.g., digital logic). This description will proceed with a discussion of FIG. 4.

FIG. 4 is a flow diagram illustrating operations for presenting streaming video content in a gaming machine, according to example embodiments of the invention. The flow diagram 400 commences at block 402.

At block 402, a wagering base game or bonus event is conducted. For example, a gaming machine's gaming control unit 132 conducts a wagering base game or bonus event. The flow continues at block 404.

At block 404, a trigger event is detected. For example, the gaming control unit 132 detects a trigger event, during a wagering base game or bonus event.

According to embodiments, trigger events can include satisfaction of certain game conditions, user input under certain game conditions (e.g., player selects a game element using a touchscreen), random number generator results, or other detectable game states. Example trigger events will be described in greater detail below, in the discussion of the flow diagrams. The flow continues at block 406.

At block 406, processing effects and a streaming video segment are selected based on the trigger event. For example, based on the trigger event, the gaming control unit 132 selects streaming video processing effects and a video segment. Video processing effects are described in greater detail below. The flow continues at block 408.

At block 408, the streaming video segment is processed according to the selected processing effects. For example, the video unit 130 processes the streaming video segment according to the selected video processing effects. In one embodiment, the streaming video processing effects can include mirroring, fading, chroma key processing, cutting, coloring, wrapping, and zooming. According to embodiments, any suitable streaming video processing effects can be used. The flow continues at block 410.

At block 410, the processed streaming video segment is presented. For example, the video unit 130 presents the processed streaming video segment on the primary display 112 or secondary display 110. The flow continues at block 412.

At block 412, a determination is made about whether there may be additional trigger events. For example, the gaming control unit 132 determines whether there may be additional trigger events. If there may be additional trigger events, the flow continues at block 402. Otherwise, the flow continues at block 414.

At block 414, the wagering base game or bonus event is concluded. For example, a gaming control unit 132 concludes a game of slots or a slots bonus event. From block 414, the flow ends.

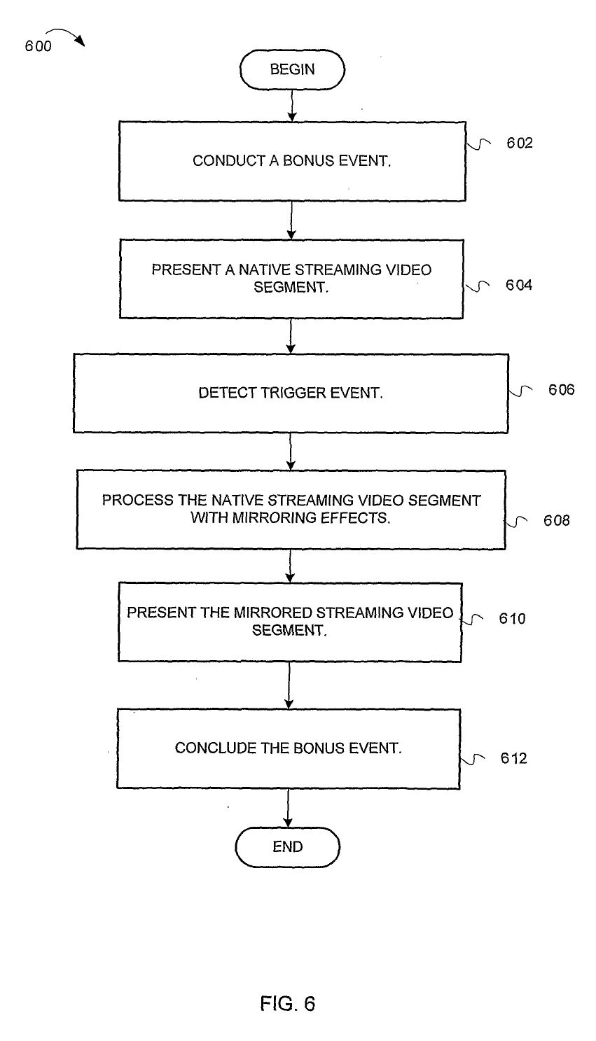

While FIG. 4 describes a general flow for processing and presenting streaming video in a gaming machine, FIGS. 5-6 describe some of the many possible game scenes in which native streaming video can be processed and presented with “mirroring” effects.

FIG. 5 is a block diagram illustrating native and mirrored streaming video segments, according to example embodiments of the invention. FIG. 5 includes a native streaming video segment 502 and a mirrored streaming video segment 508. The mirrored streaming video segment 508 appears as a mirror image of the native video segment 502. In particular, the native segment's car 504 and tree 506 appear “flipped” in the mirrored video segment 508. Operations for presenting mirrored streaming video in a gaming machine are described below, in the discussion of FIG. 6.

FIG. 6 is a flow diagram illustrating operations for presenting streaming video using mirroring effects, according to example embodiments of the invention. FIG. 6 will be described with reference to the native and streaming video segments of FIG. 5. The flow diagram 600 begins at block 602.

At block 602, the gaming control unit 132 conducts a bonus event. The flow continues at block 604.

At block 604, the video unit 130 presents a native streaming video segment 502 on the secondary display 110. The flow continues at block 606.

At block 606, the gaming control unit 132 detects a trigger event. In one embodiment, the gaming control unit detects input from the pushbuttons 118 when the game is in a specific state. For example, during a bonus event, a player can steer the car 504 by pressing the pushbuttons 118. As the player steers the car 504, the gaming control unit 132 detects the steering, which is a trigger event. The flow continues at block 608.

At block 608, the video unit 130 processes the native streaming video segment with mirroring effects. For example, the video unit's video effects unit 204 receives the native streaming video segment 502 from the streaming video store 134. The video effects unit 204 converts the native streaming video segment 502 into a video segment 508 including mirroring effects. The flow diagram continues at block 610.

At block 610, the video unit 130 presents the mirrored streaming video segment 508 on the secondary display 110. In one embodiment, in order to present streaming video, the video unit's video codec 206 decodes the streaming video according to a suitable video format (e.g., MPEG), while the video presentation unit 210 transmits the decoded streaming video to a display device (e.g., the secondary display 110) for presentation. The flow continues at block 612.

At block 612, the gaming control unit 132 concludes the bonus event.

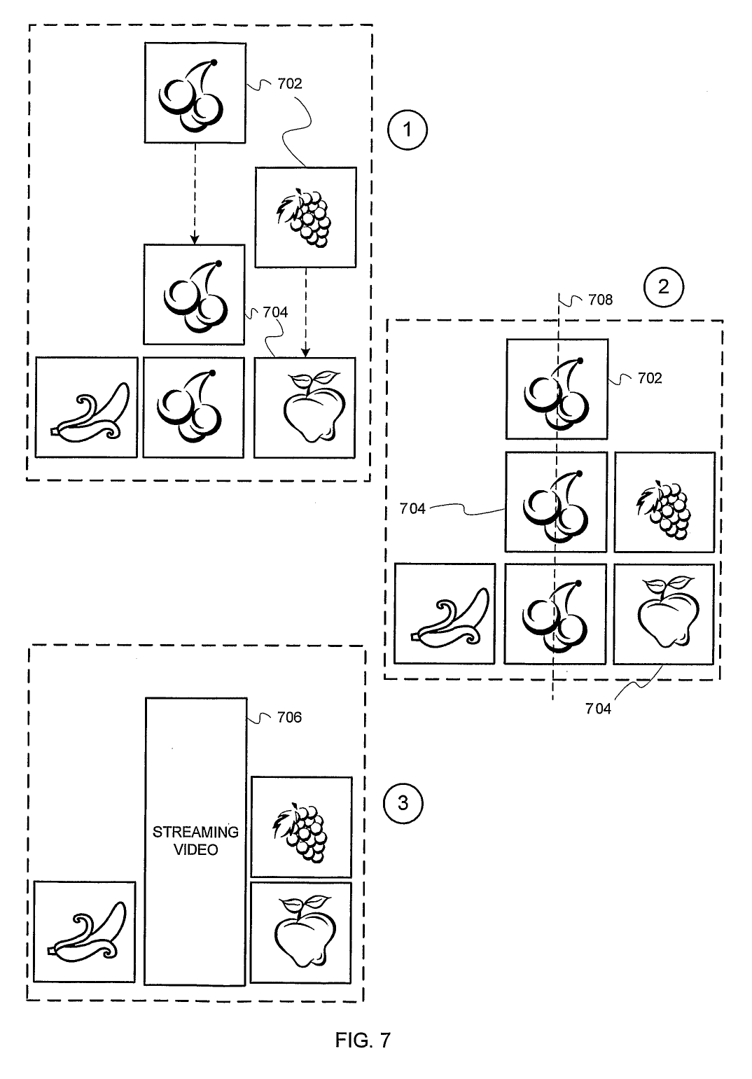

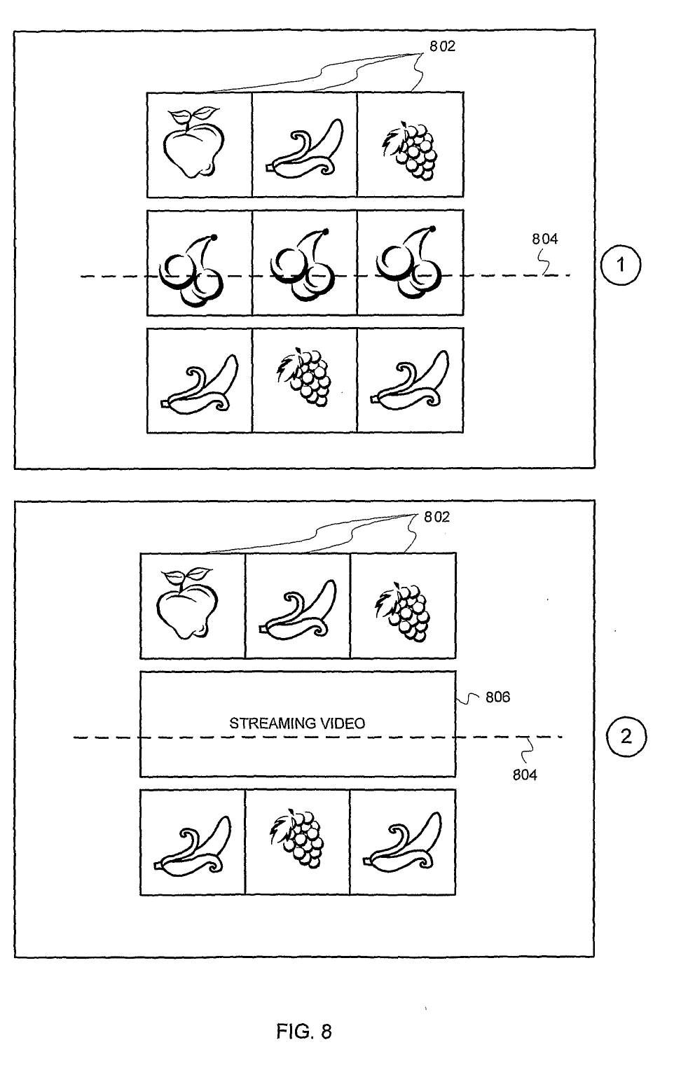

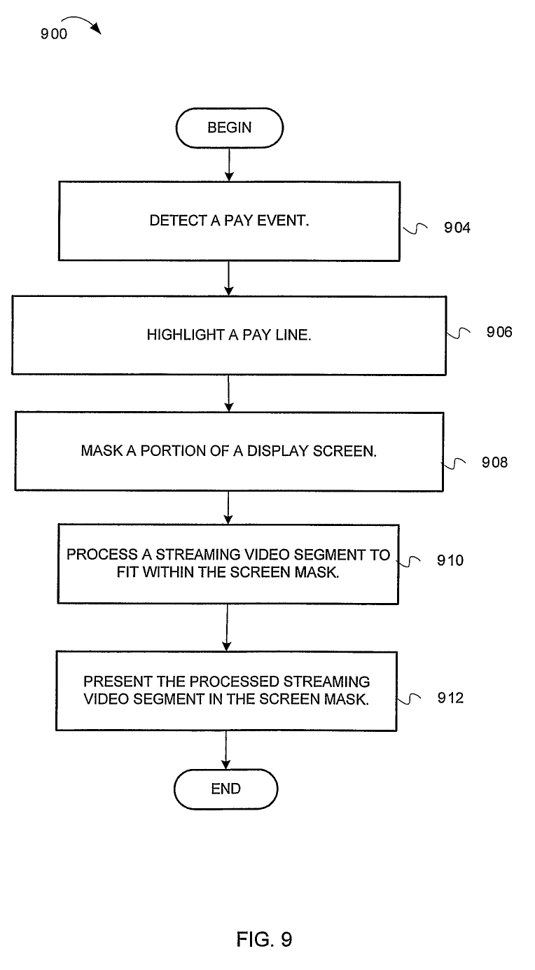

This description will continue with a discussion of FIGS. 7-9, which provide another example of using streaming video effects in a gaming machine. FIGS. 7 and 8 show game scenes in which streaming video is presented, while FIG. 9 shows operations for presenting the game scenes.

FIG. 7 is a block diagram illustrating a wagering game in which there is a streaming video presentation, according to example embodiments of the invention. FIG. 7 shows three stages of a wagering game. At stage one, game elements 702 fall on game elements 704. Stage two shows the game elements aligned along a payline 708, after falling in stage 1. In one embodiment, this particular alignment of game elements constitutes an event triggering presentation of a streaming video segment. At stage three, a streaming video segment is presented in the space 706 occupied by certain of the game elements. FIG. 8 describes another game situation that calls for streaming video.

FIG. 8 is a block diagram illustrating a slots game including a streaming video presentation, according to example embodiments of the invention. FIG. 8 shows two stages of a slots game. At stage one, after a spin of the video slot machine reels 802, certain of the reel symbols (e.g. cherries) are aligned along a payline 804. In one embodiment, the alignment of reel symbols along the payline 804 triggers a streaming video presentation in the space 806 occupied by the aligned real symbols. The discussion of FIG. 9 will describe operations for presenting the streaming video described in FIGS. 7 and 8.

FIG. 9 is a flow diagram illustrating operations for conducting a wagering game in which streaming video is presented, according to example embodiments of the invention. The discussion of FIG. 9 will refer to the wagering game scenes shown in FIGS. 7-8. The flow diagram 900 begins at block 904.

At block 904, the gaming control unit 132 detects a pay event. For example, the gaming control unit 132 detects that its random number generator (not shown) has produced a result that calls for dispensing a monetary award. The flow continues at block 906.

At block 906, the gaming control unit 132 highlights a payline in a wagering game scene. For example, the gaming control unit 132 highlights the game elements aligned on the payline 708 (see FIG. 7) or payline 804 (see FIG. 8). The flow continues at block 908.

At block 908, the video unit's video effects unit 204 masks a portion of the display screen. For example, the video effects unit 204 masks the space 706 of the game scene (space 806 in FIG. 8). The flow continues at block 910.

At block 910, the video effects unit 204 processes a streaming video segment to fit within the screen mask. In one embodiment, the video effects unit 204 transforms the video stream's aspect ratio to fit within a given screen mask. The flow continues at block 912.

At block 912, the video presentation unit 210 presents the processed streaming video segment within the screen mask.

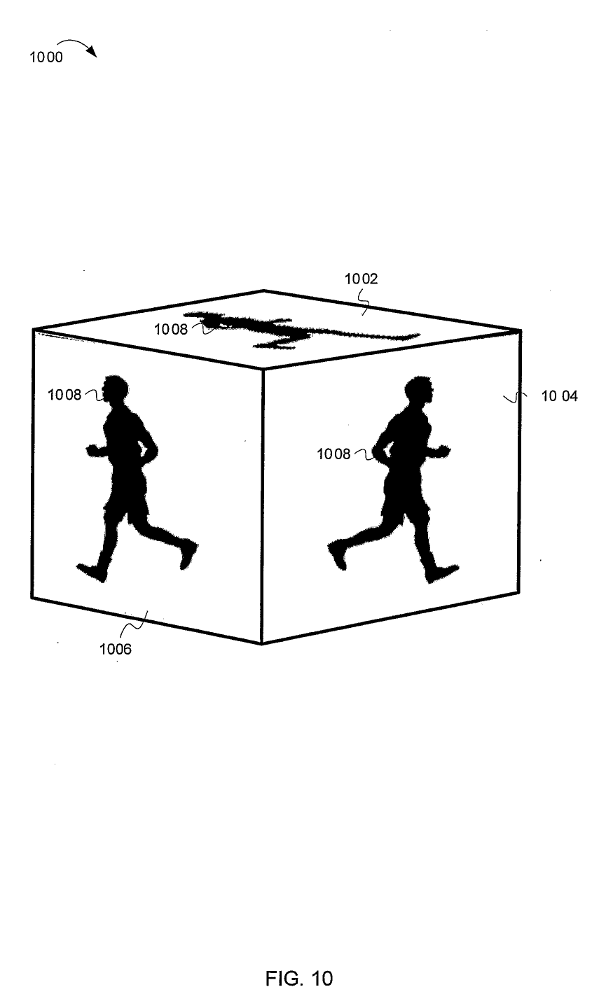

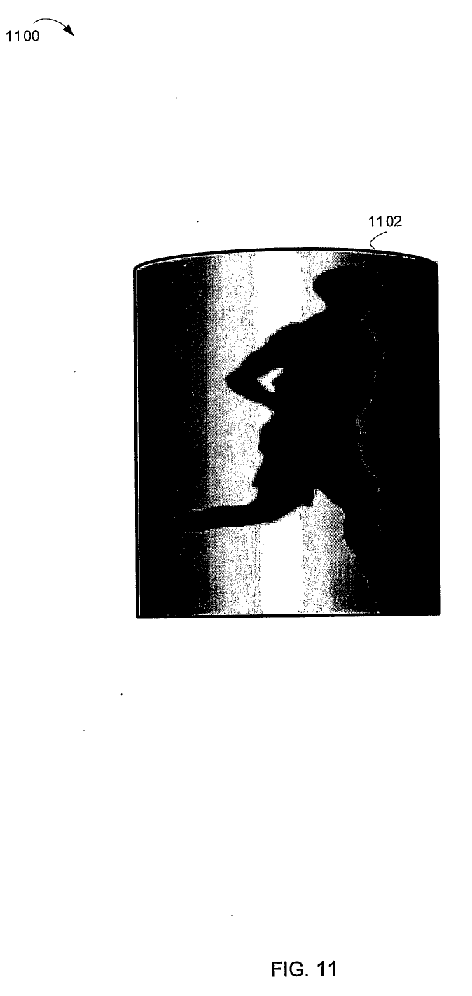

FIGS. 10-12 describe additional examples in which gaming machines present streaming video as part of a wagering base game or bonus event. FIGS. 10 and 11 show streaming video mapped to one or more surfaces of a three dimensional shape.

FIG. 10 is a block diagram illustrating video streams mapped to surfaces of a cube, according to example embodiments of the invention. FIG. 10 shows a cube 1100, which includes six sides, three of which are visible (1002, 1004, and 1006). One streaming video segment 1008 is shown on each of the visible sides of the cube 1100.

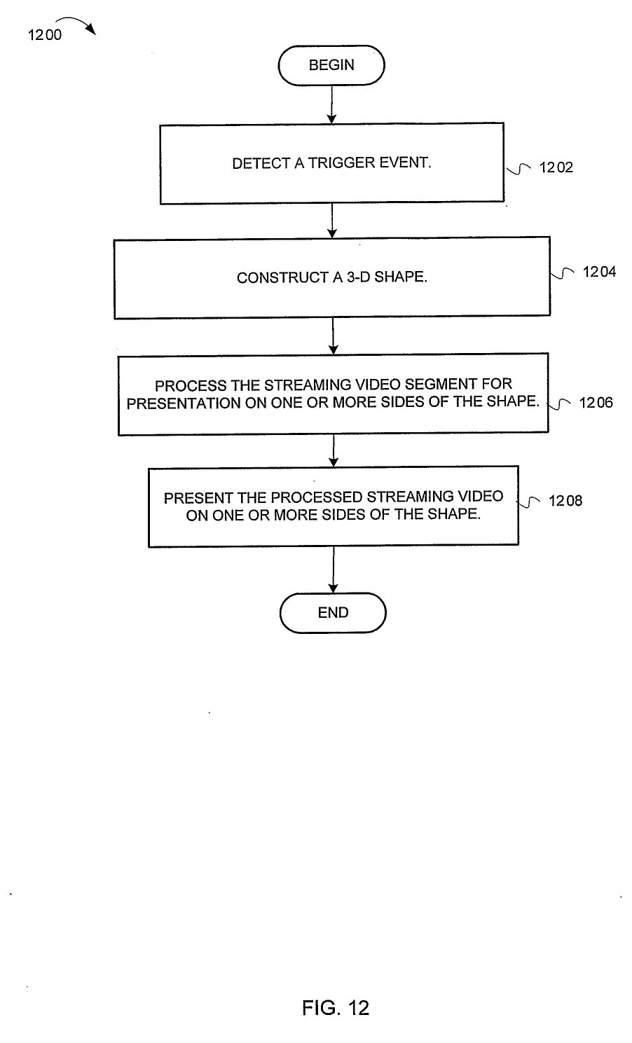

FIG. 11 is a block diagram illustrating a video stream mapped to a surface of cylinder, according to example embodiments of the invention. As shown in FIG. 11, a streaming video segment 1102 is presented on a side of cylinder 1100. Operations for presenting streaming video segments on three dimensional shapes are described below in FIG. 12.

FIG. 12 is a flow diagram illustrating operations for conducting wagering game in which streaming video segments are presented on three dimensional shapes, according to example embodiments of the invention. The flow diagram 1200 will be described with reference to the three dimensional shapes shown in FIGS. 11 and 12. The flow diagram 1200 commences at block 1202.

At block 1202, the gaming control unit 132 detects a trigger event. The flow continues at block 1204.

At block 1204, the gaming control unit 132 constructs a three dimensional shape, such as a cube or cylinder. The flow continues at block 1206.

At block 1206, the video unit 130 processes a streaming video segment to appear on one or more sides of the three dimensional shape. For example, the video effects unit 204 can map a native streaming video segment onto one or more sides of a cube or cylinder. In one embodiment, mapping the streaming video segment may call for manipulating the video segment to appear as if it is wrapped around a curved surface (see FIG. 11).

At block 1208, the video unit's video presentation unit 210 presents the processed streaming video on a display device. From block 1208, the flow ends.

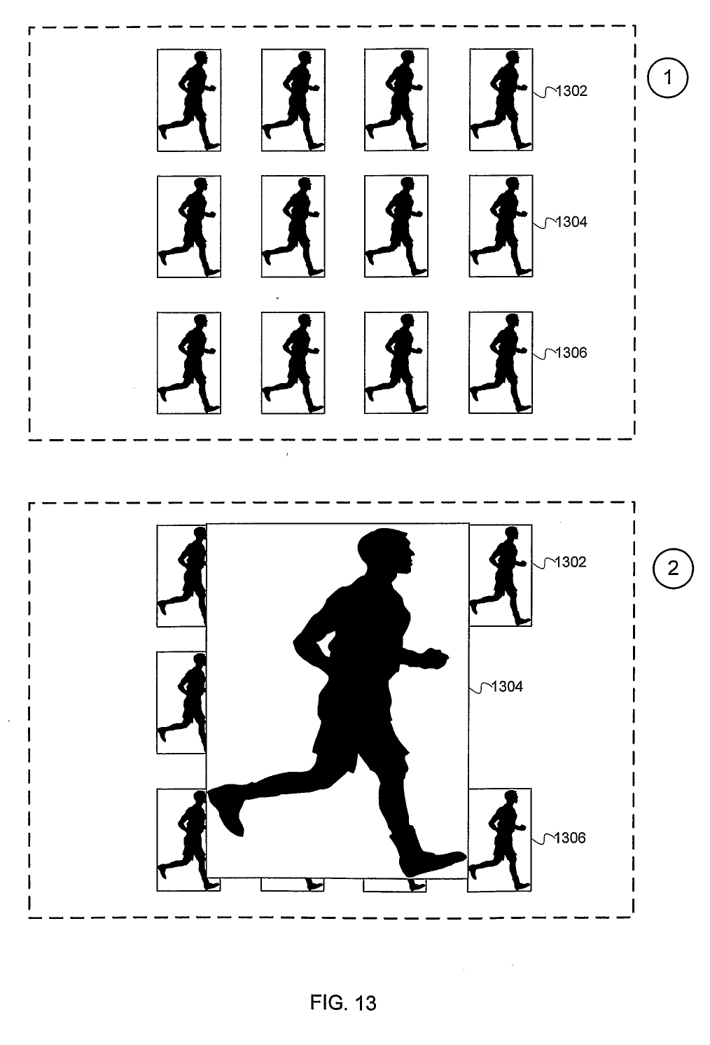

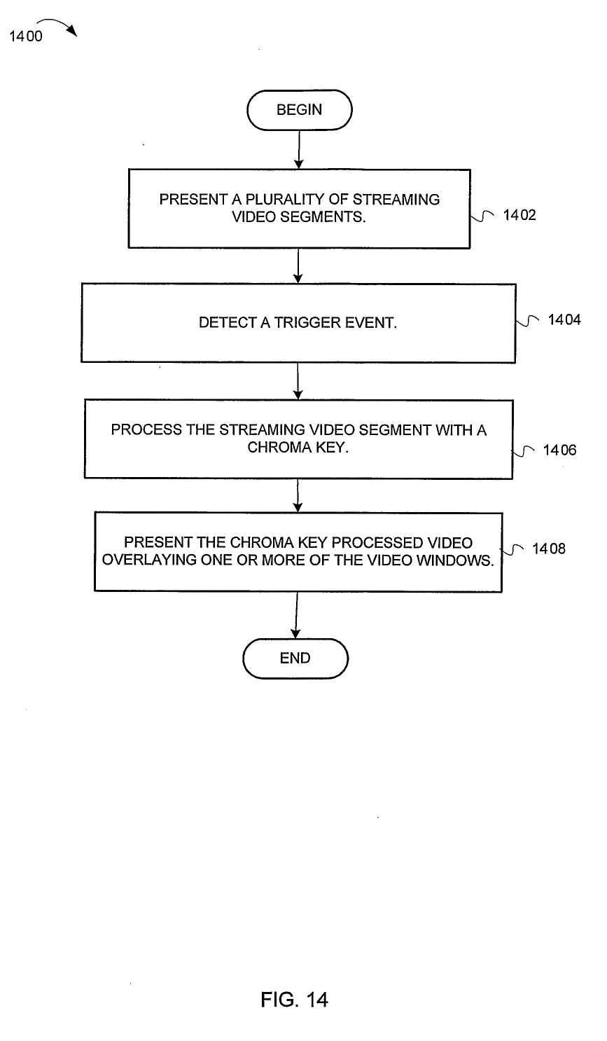

FIGS. 13 and 14 describe yet another example of presenting streaming video in a gaming machine.

FIG. 13 is a block diagram illustrating a game scene in which multiple streaming video segments are presented simultaneously, according to example embodiments of the invention. FIG. 13 shows a wagering game at two different stages. At stage one, the wagering game includes several streaming video segments (1302, 1304, and 1306). At stage two, the wagering game includes one of the streaming video segments superimposed on a plurality of the other streaming video segments. In one embodiment, the streaming video segment 1304 is processed using chroma key processing before superimposing it over other streaming video segments. In one embodiment, chroma key processing includes removing everything from an image around a certain colored area and replacing what has been removed with another stream, color, or graphic element. Operations for presenting multiple streaming video segments are described below in the discussion of FIG. 14.

FIG. 14 is a flow diagram illustrating operations for presenting multiple streaming video segments in a video game scene, according to example embodiments of the invention. The flow 1400 will be described with reference to the game scenes shown in FIG. 13. The flow 1400 commences at block 1402.

At block 1402, the video unit 130 presents a plurality of streaming video segments on a display device. The flow continues at block 1404.

At block 1404, the gaming control unit 132 detects a trigger event. The flow continues at block 1406.

At block 1406, the video unit's video effects unit 204 processes one of the video streams 1304 with a chroma key. The flow continues at block 1408.

At block 1408, the video presentation unit 210 presents the chroma keyed streaming video segment superimposed over one or more of the streaming video segments. From block 1408, the flow ends.

In addition to the streaming video effects described above in the discussion of FIGS. 4-14, embodiments of the invention can employ other suitable streaming video effects. In one embodiment, the video unit 130 can cut between scenes in response to a trigger event. The video unit 130 can also apply video effects, such as fading-in and fading-out between scene cuts and wiping images. In one embodiment, wiping includes moving one image atop another to replace it on a display screen. Wipes can occur from left to right, right to left, top to bottom to top, etc. A wipe can start from the center of the screen and be formed in a geometric shape such as a circle, box, rectangle, etc.

In one embodiment, video unit 130 can recolor, posterize, and/or rotate streaming video segments. Additional video effects can include adjusting light intensity, zooming-in/zooming-out, and adding fog or other weather effects to steaming video segments. In one embodiment, the video unit can present streaming video segments superimposed over or integrated with computer-generated graphics.

In some embodiments, the gaming machine 106 includes a digital camera or other image capture device for capturing a player's image. In one embodiment, the video unit 130 can integrate the player's image into streaming video segments, which it then presents as part of a wagering game or bonus event.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “example embodiment” means that the embodiment being referred to serves as an example or illustration.

Herein, block diagrams illustrate example embodiments of the invention. Also herein, flow diagrams illustrate operations of the example embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

1. A wagering game machine comprising:
a gaming control unit to conduct a wagering game and a bonus event and to detect occurrence of a trigger event, the trigger event to occur during the wagering game or bonus event;
a streaming video store to store a plurality of streaming video segments;
a video unit to process one or more of a plurality of streaming video segments as part of the wagering game, the video unit including,
a streaming video processing unit to add streaming video effects to ones of the plurality of streaming video segments, wherein the streaming video effects are associated with the trigger event; and
a video codec to decode the plurality of streaming video segments; and
a display unit to present the streaming video segments.

2. The wagering game machine of claim 1, wherein the wagering game is selected from the group consisting of slots, poker, blackjack, and roulette.

3. The wagering game machine of claim 1, wherein the plurality of streaming video segments are encoded according to any of MPEG, AVI, WVM, QuickTime®, RealPlayer®, DivX®, RealNetworks® video encoding formats.

4. The wagering game machine of claim 1, wherein the trigger event includes slot machine reels aligned along a payline.

5. The wagering game machine of claim 1, wherein the trigger event occurs during the bonus event, and wherein the trigger event includes receiving player input.

6. The wagering game machine of claim 1, the streaming video processing unit to add streaming video effects to ones of the plurality of streaming video segments by changing aspect ratios, modifying lighting, mirroring, zooming, fusing, fading, or cutting between the ones of the plurality of streaming video segments.

7. The wagering game machine of claim 1, wherein the streaming video store is selected from the group consisting of a DVD drive, CD-ROM drive, hard disk drive, or semiconductor memory device.

8. A method comprising:
detecting satisfaction of a condition in a wagering game;
determining which one of a plurality of streaming video effects are associated with the condition;
applying to a streaming video segment the one of the plurality of streaming video effects associated with the condition; and
displaying the streaming video segment on a display device.

9. The method of claim 8, wherein the condition is associated with a bonus event of the wagering game.

10. The method of claim 8, wherein the condition is satisfied in-part by a result of a random number generator.

11. The method of claim 8, wherein the condition is satisfied in-part by player input.

12. The method of claim 8, wherein the plurality of streaming video effects include modifying an aspect ratio of the streaming video segment, mapping the streaming video segment to a side of a three dimensional shape, applying lighting effects to the streaming video segment, wrapping the streaming video segment around a three dimensional shape, or mirroring the streaming video segment.

13. The method of claim 8, wherein the displaying the streaming video segment includes presenting at least 14 video frames per second.

14. A machine-readable medium which when executed by a machine causes the machine to perform operations comprising:
conducting a wagering game or bonus event, wherein the conducting includes,
detecting a trigger event;
selecting a streaming video segment and video effects, the selecting based on the trigger event;
processing the streaming video segment with the video effects; and
presenting the processed streaming video on a display.

15. The machine-readable medium of claim 14, wherein the trigger event includes satisfaction of a wagering game condition, user input received under certain game conditions, random number generator results, or occurrence of a game state.

16. The machine-readable medium of claim 14, wherein the operations further comprise:
decoding the streaming video according to any of MPEG, AVI, WVM, or QuickTime formats.

17. The machine-readable medium of claim 14, wherein the video effects include mirroring the streaming video segment, mapping the streaming video segment to a side of a three dimensional shape, or chroma keying the streaming video segment.

18. The method of claim 14, wherein the displaying the streaming video segment includes presenting at least 14 video frames per second.

19. The machine-readable medium of claim 14, wherein the operations further comprise:
receiving the streaming video segment from a DVD drive, CD-ROM drive, hard disk drive, semiconductor memory device, or network interface.
